(19) United States
(12) Patent Application Publication
(10) Pub. No.: US 2026/0370429 A1
(43) Pub. Date: Nov. 19, 2026

(54) METHOD FOR POSITIONING UNDER SHARED CARRIER

(71) Applicant: ZTE CORPORATION, Shenzhen, Guangdong (CN)

(72) Inventors: Focai PENG, Shenzhen (CN); Chuangxin JIANG, Shenzhen (CN); Junpeng LOU, Shenzhen (CN); Qi YANG, Shenzhen (CN); Mengzhen LI, Shenzhen (CN); Cong WANG, Shenzhen (CN); Zhiqiang HAN, Shenzhen (CN)

(21) Appl. No.: 19/137,051

(22) PCT Filed: Jul. 31, 2023
(86) PCT No.: PCT/CN2023/110432

§ 371 Date: Jun. 9, 2025

(51) Int. Cl. H04L 5/00; H04W 24/10; H04W 64/00; H04W 74/0808

(52) U.S. Cl. CPC H04L 5/0094; H04W 24/10; H04W 64/006; H04W 74/0808

(57) ABSTRACT

A wireless communication method is disclosed. The method may include receiving, by a first wireless communication entity from a second wireless communication entity, configuration information about a reference signal for positioning. The method may include sending, by the first wireless communication entity to the second wireless communication entity, a transmission of the reference signal for positioning based on the configuration information.

### CROSS REFERENCE

This disclosure is a national stage filing under 35 U.S.C. § 371 of international application number PCT/CN2023/110432, filed Jul. 31, 2023, the entire contents of which are incorporated herein by reference.

### TECHNICAL FIELD

The disclosure relates generally to wireless communications, including but not limited to systems and methods for positioning.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication entity (e.g., a UE, a radio device) may receive configuration information about a reference signal for positioning (e.g., a positioning reference signal (PRS)) from a wireless communication node. The wireless communication entity may send a transmission of the reference signal for positioning. The transmission may include an occupancy signal based on a de-modulation reference signal (DM-RS) of a physical sidelink control channel (PSCCH) that schedules the reference signal for positioning.

In some embodiments, the transmission may include an occupancy signal based on an automatic gain control (AGC) symbol that is just before a PSCCH that schedules the reference signal for positioning. The transmission may include an occupancy signal based on a de-modulation reference signal (DM-RS) of a physical downlink control channel (PDCCH) that schedules the reference signal for positioning. The transmission may include an occupancy signal based on an automatic gain control (AGC) symbol that is just before a PSCCH that schedules the reference signal for positioning.

In some embodiments, the configuration information may indicate that when a time-gap between a successful listen before talk (LBT)/clear channel assessment (CCA) and a pre-defined start time of a PSCCH that schedules the reference signal for positioning is greater or equal to the first wireless communication entity processing capability of AGC, sending the transmission. The transmission may include an occupancy signal copied from an incoming PSCCH symbol.

In some embodiments, the reference signal for positioning may be configured as a Comb-based signal, and wherein when a time-gap between a successful LBT/CCA and a pre-defined end time of the reference signal for positioning is less than CombSize/Q orthogonal frequency division multiplexing (OFDM) symbol(s), the reference signal for positioning is not sent, where CombSize is a comb size and Q is an integer. The reference signal for positioning may be configured as a Comb-based signal, and wherein when a time-gap between a successful LBT/CCA and a pre-defined end time of the reference signal for positioning is less than CombSize OFDM symbol(s), the reference signal for positioning is not sent, where CombSize is a comb size. The reference signal for positioning may be configured as a Comb-based signal, and wherein when a time-gap between a successful LBT/CCA and a pre-defined end time of the reference signal for positioning is less than CombSize/Q OFDM symbol(s) plus a duration for AGC, the reference signal for positioning is not sent, where CombSize is a comb size and Q is an integer. The reference signal for positioning may be configured as a Comb-based signal, and wherein when a time-gap between a successful LBT/CCA and a pre-defined end time of a PSCCH that schedules the reference signal for positioning is less than CombSize/Q OFDM symbol(s) plus a duration for AGC, the reference signal for positioning is not sent, where CombSize is a comb size and Q is an integer. The reference signal for positioning may be configured as a Comb-based signal, and wherein when a time-gap between a successful LBT/CCA and a pre-defined end time of the reference signal for positioning is less than CombSize OFDM symbol(s) plus duration for AGC, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for AGC, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for a PSCCH/PDCCH that schedules the reference signal for positioning, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for AGC and a duration for a PSCCH/PDCCH that schedules the reference signal for positioning, the reference signal for positioning is not sent, where CombSize is a comb size.

In some embodiments, the configuration information may indicate an LBT/CCA type associated with CombSize of the reference signal for positioning, where CombSize is a comb size. The configuration information may indicate that a PSCCH starts with a first interlace while the reference signal for positioning starts with a second interlace. The configuration information may indicate that every M RBs out of a bandwidth composes an interlace, where M is an integer. The configuration may indicate one or more CombSize interlaces for the transmission of the reference signal positioning, where CombSize is a comb size. The configuration information may indicate information indicates an interlace that contains RBs, each of the RBs associated with an RB index. The configuration information may indicate more than one sub-interlace within an interlace. The configuration information may indicate a sub-interlace indicator in a PSCCH/PSSCH/PDCCH.

In some embodiments, the reference signal for positioning may be configured as a Comb-based signal, and wherein when a remaining duration of a COT (RemainingDuration) is less than CombSize OFDM symbols, RemainingDuration−CombSize/Q OFDM symbols are dropped, where CombSize is a comb size and Q is an integer. In some embodiments, the reference signal for positioning may be configured as a Comb-based signal, and wherein when a remaining duration of a COT (RemainingDuration) is less than CombSize×RepetitionFactor OFDM symbols, RemainingDuration−CombSize×RepetitionFactor/Q OFDM symbols are dropped, where CombSize is a comb size and Q is an integer. In some embodiments, the reference signal for positioning may be configured as a Comb-based signal, and wherein when a remaining duration of a COT (RemainingDuration) is less than P×CombSize OFDM symbols and more than or equal to CombSize OFDM symbols, RemainingDuration−(P−1)×CombSize OFDM symbols are a repetition of CombSize−1 OFDM symbols, where CombSize is a comb size and P is an integer.

In some embodiments, the configuration information may include an energy detection threshold, and wherein the energy detection threshold is included in COT sharing information. In some embodiments, the energy detection threshold may be associated with a number of simultaneous transmissions of the reference signal for positioning. The energy detection threshold may be associated with Comb Size of the reference signal for positioning. The energy detection threshold may be associated with a number of interlaces.

In some embodiments, the configuration information may indicate quasi-co-location (QCL) information included in COT sharing information. The configuration information may indicate a transmission configuration indicator included in COT sharing information. The configuration information may indicate interlace information included in COT sharing information. The configuration information may indicate a LBT/CCA bandwidth included in COT sharing information. The configuration information may indicate the reference signal for positioning in one resource pool (RP) (or resource, or resource set) as a beam reference (or QCL source) of another reference signal for positioning in another RP. The configuration information may indicate that when a wireless communication device reports measurement results of the reference signal for positioning, a resource index is attached. The configuration information may indicate that, when a wireless communication device reports measurement results of the reference signal for positioning, a timestamp is attached. The configuration information may indicate a physical sidelink feedback channel (PSFCH) for measuring a beam direction. In some embodiments, the PSFCH shares a COT of the reference signal for positioning. The configuration information may indicate that the reference signal for positioning starts at symbol ID when mod(SymbolID, CombSize)==T is satisfied, wherein SymbolID is a symbol ID within a slot, CombSize is a comb size of the reference signal for positioning, and T is an integer.

In some embodiments, the transmission may include a COT duration associated with a comb size of the reference signal for positioning or a repetition factor of the reference signal for positioning.

In some embodiments, a wireless communication device may identify configuration information about a reference signal for positioning sent from a second wireless communication device. The wireless communication device may measure the reference signal for positioning. The wireless communication device may send a report including a measurement result of the reference signal for positioning. In some embodiments, the measurement result may include the reference signal for positioning in one RP (or resource, or resource set) as a beam reference (or QCL source) of another reference signal for positioning in another RP.

In some embodiments, the configuration information may indicate that when sending the report, a resource index should be attached. In some embodiments, the resource index may include a PRS resource index, a SL-PRS resource index, or a SRS resource index. The configuration information may indicate that when sending the report, a timestamp can be attached. In some embodiments, the timestamp may include a system frame number (SFN), a slot number within a frame, or a symbol index within a slot.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of positioning, in accordance with some embodiments of the present disclosure;

FIG. 4 illustrates an example implementation of positioning, in accordance with some embodiments of the present disclosure;

FIG. 5 illustrates a flow diagram of an example method for positioning, in accordance with an embodiment of the present disclosure; and

FIG. 6 illustrates a flow diagram of an example method for positioning, in accordance with an embodiment of the present disclosure.

### DETAILED DESCRIPTION

### a. Mobile Communication Technology and Environment

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

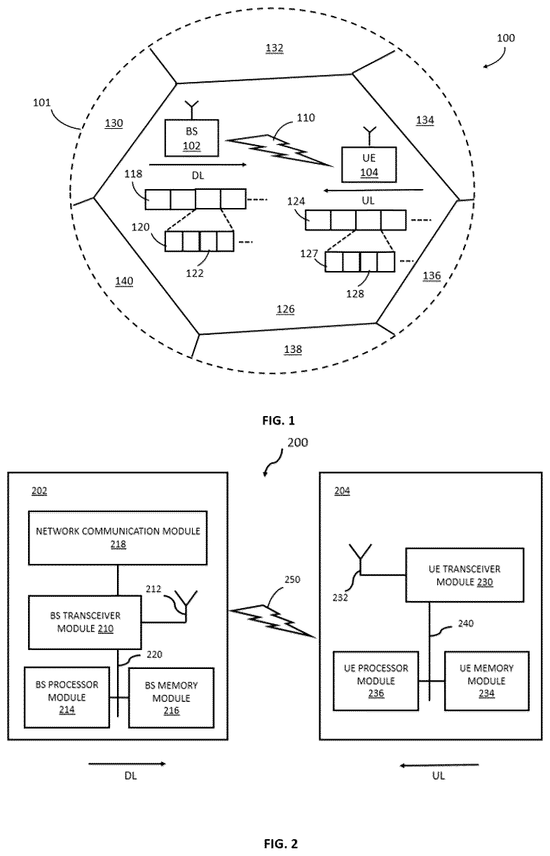

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### b. Systems and Methods for Positioning

A demand for positioning is rising up. For example, in a park (especially, an underground park), it may not be easy to find a car (especially, during busy hour). The 5th generation mobile communication system (e.g., 5G, new radio access technology, or 5G-NR) may provide a method for positioning (e.g., positioning reference signal (PRS, from a base station (e.g., gNB)) and/or sounding reference signal (SRS, from a user equipment (UE)) on a radio side. However, a positioning accuracy of the existing 5G-NR-based positioning solutions may not be high enough (e.g., one meter or worse). In some harsh environments (e.g., dense urban area), the positioning accuracy of the existing 5G-NR-based positioning solution can be even worse. In some commerce cases, a positioning accuracy of 0.2 meter can be required. In some cases, a target of some commerce cases (e.g., 0.2 meter) can be hard to be achieved by the existing 5G-NR-based positioning solution. This disclosure is related to positioning accuracy improvement for 5G-NR-based positioning.

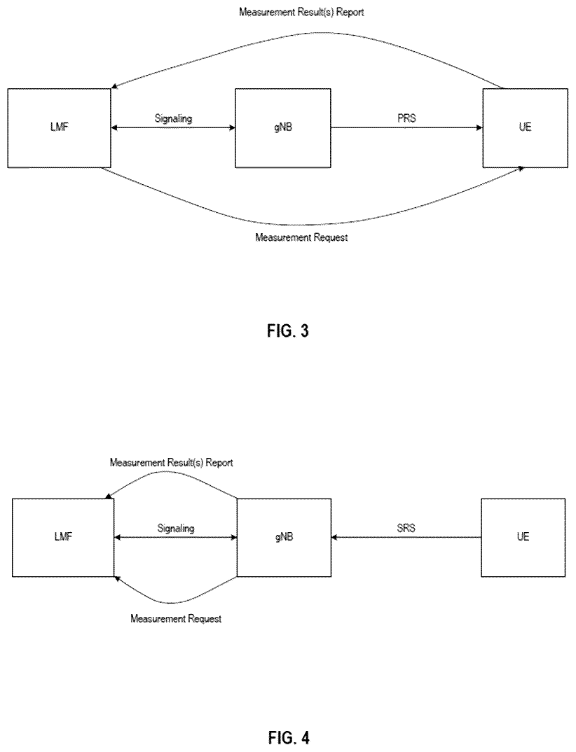

This disclosure relates to a radio communication about how to improve positioning accuracy for a 5G-NR-based positioning. In a downlink (DL) as shown in FIG. 3, a positioning reference signal (PRS) can be transmitted by one or multiple gNBs. In order to achieve a “good” positioning accuracy, multiple gNBs can be involved (e.g., three base stations). A UE may measure at least one PRS. The UE may report measurement result(s) to a network (e.g., a Location Management Function (LMF) in a core network (CN) or a 5G CN (5GC)). A network element may include at least one of: a gNB, a CN, or a UE.

In an uplink (UL) as shown in FIG. 4, a sounding reference signal (SRS) can be transmitted by a UE. One or more gNBs (e.g., multiple gNBs) may measure the SRS. The one or more gNBs may report measurement result(s) to a network (e.g., a LMF).

A transmission of PRS and/or SRS for purpose of positioning can be easily affected by a radio propagation environment (e.g., fading, distortion). Hence, the positioning accuracy can be limited. This disclosure can provide a method for higher positioning accuracy.

### Implementation Example 1: Occupy an Unlicensed Carrier With a Signal/Channel

The 5G-NR is a time synchronization system, where a channel/signal may transmit a pre-defined time framework (e.g., a symbol, a slot) when a pre-defined time is reached.

An unlicensed carrier (e.g., a shared spectrum, an unlicensed channel) may contain many types of wireless communication devices (e.g., wireless fidelity, WiFi device, blue-tooth device). A wireless communication device may transmit a channel/signal with different timing from that of the 5G-NR system. Furthermore, an unlicensed carrier is occupied with competition (e.g., via listen before talk, LBT, or clear channel assessment, CCA. Here, a channel is an unlicensed carrier or a shared carrier).

After a successful LBT/CCA, the wireless communication device may transmit a channel/signal (e.g., position reference signal, PRS,) to occupy the unlicensed carrier for a future transmission of channel/signal.

An occupancy channel/signal (e.g., cyclic pre-fix extension, CPE, or CPE channel/signal) is used to occupy the unlicensed carrier before transmission of a channel/signal. Alternatively, the occupancy signal/channel may be included in a de-modulation reference signal (DM-RS). Alternatively, the occupancy channel/signal may be included in a DM-RS of physical sidelink control channel (PSCCH). Alternatively, the occupancy signal/channel may be included in a DM-RS of PSCCH that schedule SL-PRS (sidelink-position reference signal). Alternatively, the occupancy channel/signal may be based on DM-RS of PSCCH that schedule SL-PRS. In some embodiments, it is helpful for DM-RS based channel-sensing (e.g., energy detection, with energy accumulation on occupancy signal and real transmission of DM-RS).

Alternatively, the occupancy channel/signal may be included in a DM-RS of physical downlink control channel (PDCCH) or enhanced physical downlink control channel (EPDCCH). Alternatively, the occupancy signal/channel may be included in a DM-RS of PDCCH that schedule PRS. Alternatively, the occupancy channel/signal may be based on DM-RS of PDCCH that schedule PRS.

Alternatively, the occupancy channel/signal may be included in a SL-PRS. Alternatively, the occupancy signal/channel may be based on SL-PRS.

Alternatively, the occupancy channel/signal can be PRS or SRS (sound reference signal). Alternatively, the occupancy channel/signal may be based on PRS or SRS.

Alternatively, the occupancy signal/channel may be included in an automatic gain control (AGC) symbol. Alternatively, the occupancy channel/signal may be included in an AGC symbol that is just before SL-PRS. Alternatively, the occupancy signal/channel may be included in an AGC symbol that is just before PSCCH. Alternatively, the occupancy channel/signal may be included in an AGC symbol that is just before PSCCH that schedules SL-PRS.

Alternatively, the occupancy channel/signal may be included in a channel-state information reference signal (CSI-RS, e.g., from gNB or, SL CSI-RS from a SL UE).

Alternatively, the occupancy channel/signal may be included in a cyclic pre-fix extension (CPE) of the next symbol to be transmitted.

In some embodiments, If the time gap between the candidate start time before the real transmission of a signal/channel and the real transmission of this signal/channel is greater than (or equal to) one Tₛ and less than one symbol duration (e.g., 2048+144=2192 Tₛ for normal cyclic pre-fix@15 kHz of sub-carrier spacing, SCS, or 2048+160=2208 Tₛ, where one Tₛ=1/(15000*2048) seconds), then an occupancy signal/channel may be transmitted.

Furthermore, if the time gap (G) between a candidate start time, before an AGC symbol of SL is greater than (or equal to) one Tₛ, and less than one symbol duration, then an occupancy signal/channel may be transmitted. Alternatively, the transmission duration of an occupancy signal/channel may be the time gap G. With this transmission of occupancy signal/channel, a channel (or a carrier, or a spectrum) may be occupied for future transmission of SL-PRS (or PRS) which will enable positioning on an unlicensed carrier (or shared spectrum). Alternatively, the transmission duration of an occupancy signal/channel may be the time gap G. Transmission of occupancy signal/channel may specify a channel/signal to be occupied for future transmission of a SL-PRS (or PRS) which enables positioning on an unlicensed carrier.

In some embodiments, if the time gap between the candidate start time before the real transmission of a channel/signal and the real transmission of this channel/signal is greater than (or equal to) one T_{c} (where one T_{c}=1/(480000*4096) seconds, T_{c}=Tₛ/64) and less than one symbol duration then an occupancy channel/signal may be transmitted.

Alternatively, a reference signal for positioning (e.g., PRS/SRS/SL-PRS) may start at a symbol ID where mod(SymbolID, CombSize)==0 is fulfilled, wherein mod( ) is an operation of modular, the SymbolID is a symbol ID (e.g., 0, 1, 2, 13) within a slot, the CombSize is a Comb size of the reference signal for positioning. Alternatively, when the SymbolID is zero, the next symbol (i.e., SymbolID=1) may be copied as an occupancy channel/signal (or CPE). For ease of description, copied may be an operation of modular. For example, exp(−j*2π*(1+x)) will copy the value of exp(−j*2π*x) because there is an operation of modular of 2π wherein, exp( ) is an exponential function, j is the unit of imaginary number of complex number, x is an unknown variable.

Alternatively, a reference signal for positioning (e.g., PRS/SRS/SL-PRS) may start at a symbol ID when mod(SymbolID, CombSize)==T is fulfilled where the T is an integer (e.g., T=1. In addition, the T may be configured by network). With this method, a start symbol may be determined for reference signal for positioning.

With this method, a channel (or a carrier, or a spectrum) may be occupied for future transmission of SL-PRS (or PRS, or SRS) which enables positioning on an unlicensed carrier. With the transmission of occupancy channel/signal, a channel (or a carrier, e.g., a carrier with a bandwidth of 20 MHz) under an unlicensed spectrum will not be occupied by other radio devices.

### Implementation Example 2: How to Determine Timing Relationship Between CPE and AGC Symbol/Symbol for Control Channel/Symbol for Reference Signal for Positioning

For SL positioning under an unlicensed spectrum (or shared spectrum), a UE may transmit AGC and CPE symbol before the real transmission of positioning related signal/channel (e.g., PSCCH/SL-PRS). If the time gap between a successful LBT/CCA and the pre-defined start time of PSCCH that schedules SL-PRS is a full orthogonal frequency division multiplexing (OFDM) symbol (e.g., 2048+144=2192 Tₛ), then there can be no CPE signal (i.e., no occupancy signal/channel. i.e., AGC symbol only).

For AGC tuning, different UE may have different capability (e.g., some UE require 2192 Tₛ, some UE require 1024 Tₛ). A UE may report its processing capability of AGC to the network (or to another UE, e.g., server UE). If the time gap between a successful LBT/CCA and the pre-defined start time of PSCCH that schedules SL-PRS is greater or equal to UE's processing capability of AGC, then the occupancy channel/signal (i.e., CPE or CPE signal) is transmitted (by this UE). The occupancy signal/channel may be copied from the incoming PSCCH symbol (in a form of cyclic pre-fix) as the following where t=0 is the start time of real transmission of the PSCCH that schedules SL-PRS.). For ease of description, copied may be an operation of modular. For example, exp(−j*2π*(1+x)) will copy the value of exp(−j*2π*x) because there is an operation of modular of 2π wherein, exp( ) is an exponential function, j is the unit of imaginary number of complex number, x is an unknown variable.

Occupy(−T_{AGC}−t)=S_{PSCCH}(T_{OFDM}−T_{AGC}−t), 0≤t<T_{OFDM}−T_{AGC}

Wherein, t may be in unit of Tₛ, T_{AGC} is UE's processing capability of AGC, T_{OFDM} is the duration of an OFDM symbol (e.g., 2192 Tₛ under normal cyclic pre-fix, CP), Occupy( ) is the occupancy signal/channel (i.e., CPE), S_{PSCCH} is the time domain signal of PSCCH that schedules SL-PRS.

Alternatively, if t>TOFDM−TAGC, the following equation is applied where N=2, . . . 28.

Occupy(−T_{AGC}−t)=S_{PSCCH}(N*T_{OFDM}−T_{AGC}−t), 0≤t<T_{OFDM}−T_{AGC}

Furthermore, for DL (or UL) positioning under an unlicensed spectrum (or shared spectrum), a gNB (or a UE) may transmit CPE symbol/signal/channel before the real transmission of positioning related channel/signal (e.g., PRS/SRS).

For DL (or UL) positioning under an unlicensed spectrum (or shared spectrum), a gNB (or a UE) can transmit CPE symbol/signal/channel before the real transmission of positioning related channel/signal (e.g., PRS/SRS).

For a Comb-based transmission of PRS/SRS, if the time gap between a successful LBT/CCA and the pre-defined end time of PRS/SRS is less than CombSize/Q OFDM symbol(s), then the PRS/SRS will not be transmitted where CombSize=1, 2, 3, 4, 6, 8, 12, 24, 36, 48, the integer Q=1, 2, 3, . . . , 100. For example, for CombSize=4 and Q=2 (where Q=2 will generate a partial staggering pattern of PRS/SRS), if the time gap between a successful LBT/CCA and the pre-defined end time of PRS/SRS is less than CombSize/Q=4/2=2 symbols, then the SL-PRS/PRS/SRS will not be transmitted (i.e., a UE is not required to receive PRS/transmit SRS).

In addition, if the time gap between a successful LBT/CCA and the pre-defined end time of PRS/SRS is less than CombSize OFDM symbol(s), then the SL-PRS/PRS/SRS will not be transmitted. For example, for CombSize=4, if the time gap between a successful LBT/CCA and the pre-defined end time of PRS/SRS is less than CombSize=4 symbols (Note: this will ensure a full staggering pattern of PRS/SRS), then the PRS/SRS will not be transmitted (i.e., a UE is not required to receive PRS/transmit SRS). Otherwise (i.e., more than CombSize=4 symbols), the SL-PRS/PRS/SRS will be transmitted (i.e., a UE should receive PRS/transmit SRS).

For a Comb-based transmission of SL-PRS, if the time gap between a successful LBT/CCA and the pre-defined end time of SL-PRS is less than CombSize/Q OFDM symbol(s), then the SL-PRS/PRS/SRS will not be transmitted. Alternatively, for a Comb-based transmission of SL-PRS, if the time gap between a successful LBT/CCA and the pre-defined end time of SL-PRS is less than CombSize/Q OFDM symbol(s) plus duration for AGC, then the SL-PRS/PRS/SRS will not be transmitted.

For a Comb-based transmission of SL-PRS, if the time gap between a successful LBT/CCA and the pre-defined end time of PSCCH that schedules SL-PRS is less than CombSize/Q OFDM symbol(s), then the SL-PRS/PRS/SRS will not be transmitted. Alternatively, for a Comb-based transmission of SL-PRS, if the time gap between a successful LBT/CCA and the pre-defined end time of PSCCH that schedules SL-PRS is less than CombSize/Q OFDM symbol(s) plus duration for AGC, then the SL-PRS/PRS/SRS will not be transmitted.

For a Comb-based transmission of SL-PRS, if the time gap between a successful LBT/CCA and the pre-defined end time of SL-PRS is less than CombSize OFDM symbol(s), then the SL-PRS/PRS/SRS will not be transmitted. Alternatively, for a Comb-based transmission of SL-PRS, if the time gap between a successful LBT/CCA and the pre-defined end time of SL-PRS is less than CombSize OFDM symbol(s) plus duration for AGC, then the SL-PRS/PRS/SRS will not be transmitted.

For a Comb-based transmission of SL-PRS, if the time gap between a successful LBT/CCA and the pre-defined end time of PSCCH that schedules SL-PRS is less than CombSize OFDM symbol(s), then the SL-PRS/PRS/SRS will not be transmitted. Alternatively, for a Comb-based transmission of SL-PRS, if the time gap between a successful LBT/CCA and the pre-defined end time of PSCCH that schedules SL-PRS is less than CombSize OFDM symbol(s) plus duration for AGC, then the SL-PRS/PRS/SRS will not be transmitted.

Alternatively, for a Comb-based transmission of SL-PRS, if the time gap between a successful LBT/CCA and the pre-defined end time of SL-PRS is less than CombSize/Q OFDM symbol(s) plus duration for PSCCH/PDCCH (e.g., 2 symbols) that schedules PRS/SRS, then the SL-PRS/PRS/SRS will not be transmitted wherein, the CombSize and Q may be set to be one.

Alternatively, for a Comb-based transmission of PRS/SRS, if the time gap between a successful LBT/CCA and the pre-defined end time of PRS/SRS is less than CombSize/Q OFDM symbol(s) plus duration for EPDCCH/PDCCH (e.g., 2 symbols) that schedules PRS/SRS, when PRS/SRS is scheduled by EPDCCH/PDCCH, then the PRS/SRS will not be transmitted. Alternatively, for a Comb-based transmission of PRS/SRS, if the time gap between a successful LBT/CCA and the pre-defined end time of PRS/SRS if less than CombSize/Q OFDM symbol(s) when PRS/SRS is not scheduled by EPDCCH/PDCCH, then the PRS/SRS will not be transmitted.

Alternatively, for a Comb-based transmission of SL-PRS, if the time gap between a successful LBT/CCA and the pre-defined end time of SL-PRS is less than CombSize/Q OFDM symbol(s) plus duration for AGC and duration for PSCCH/PDCCH that schedules PRS/SRS, then the SL-PRS/PRS/SRS will not be transmitted wherein, the CombSize and Q may be set to be one.

A CPE may start in a window before the real transmission of PSCCH/SL-PRS/PDCCH/PRS/SRS/AGC. For example, one OFDM symbol ahead of the real transmission, three (or four) OFDM symbols plus 16 us (or 25 us) ahead of the real transmission at SCS=120 kHz, seven (or eight, or six) OFDM symbols plus 16 us (or 25 us) ahead of the real transmission at SCS=240 kHz.

A CPE can starts in a window before the AGC symbol of the real transmission of PSCCH/SL-PRS/PDCCH/PRS/SRS. For example, one OFDM symbol ahead of the AGC symbol of the real transmission, three (or four) OFDM symbols plus 16 us (or 25 us) ahead of the AGC symbol of the real transmission at SCS=120 kHz, seven (or eight, or six) OFDM symbols plus 16 us (or 25 us) ahead of the AGC symbol of the real transmission at SCS=240 kHz. Multiple symbols (e.g., three OFDM symbols) of CPE (or multiple CPE) is helpful for time alignment of SL-PRS/PRS/SRS between UE and base station.

Alternatively, an LBT/CCA type can be associated with the CombSize of reference signal for positioning. For example, if the CombSize (configured by higher layer) of SL-PRS is small (e.g., CombSize=1), then a LBT/CCA with short duration (e.g., 16 us) can be applied. For another example, if the CombSize of PRS is large (e.g., CombSize=12), then a LBT/CCA with long duration (e.g., 25 us) can be applied.

Alternatively, an LBT/CCA type can be associated with the CombSize and repetition factor (configured by higher layer) of reference signal for positioning.

With this method, a channel (or a carrier, or a spectrum) can be occupied for future transmission of SL-PRS (or PRS, or SRS), which will enable positioning on an unlicensed carrier (or shared spectrum). With the transmission of PRS/SRS/SL-PRS, positioning under an unlicensed spectrum may be observed after an unspecified duration (for good performance).

### Implementation Example 3: Interlaced Transmission for Reference Signal for Positioning

In some cases, a channel/signal may require few resources (e.g., several resource blocks, RB) while an unlicensed carrier (or shared spectrum) may be broader (e.g., 20 MHz, or 100 RB@SCS=15 kHz). For these cases, an interlaced transmission (or interlaced RB transmission) may be applied.

For SL positioning under an unlicensed spectrum, for a dedicated resource pool (RP) (or a shared RP), PSCCH/physical sidelink shared channel (PSSCH)/physical sidelink feedback channel (PSFCH) and SL-PRS can be allocated with different interlace(s). For example, the PSCCH that schedules SL-PRS starts with the first interlace while the corresponding SL-PRS starts with the second interlace (or an interlace different from that for PSCCH). With this method, an interlace RB-based frequency division multiplexing (FDM) may be applied for SL positioning.

For DL/UL positioning under an unlicensed spectrum, PDCCH/physical downlink shared channel (PDSCH)/physical uplink shared channel (PUSCH)/physical uplink control channel (PUCCH) and PRS/SRS can be allocated with different interlace(s). With this method, an interlace RB-based frequency division multiplexing (FDM) may be applied for DL/UL positioning.

For interlaced transmission of DL/UL/SL positioning related signal/channel under an unlicensed spectrum, every M RB out of a bandwidth is composed an interlace where the M is integer (e.g., M=1, 2, 3, . . . , 100). Alternatively, the M has the identical value of CombSize (e.g., 1, 2, 3, 4, 6, 8, 12, 24, 36, 48) of PRS/SRS/SL-PRS where the CombSize can be configured by higher layer (or network).

Alternatively, there are CombSize interlace(s) for transmission of DL/UL/SL positioning related signal/channel under an unlicensed spectrum. Alternatively, one RB of every CombSize RB out of a bandwidth is composed of an interlace. Alternatively, an interlace (i) contains those RB that have a RB index mod(RB_Index, CombSize)=i, where i is an integer, 0≤i≤CombSize−1.

Alternatively, an interlace may include sub-interlaces (segments). Alternatively, there is a sub-interlace indicator in a PSCCH/PSSCH/PDCCH. For example, for an unlicensed carrier with a bandwidth of 20 MHz (or 100 RB@SCS=15 kHz) and an interlace RB interval of M=10 RB, the first interlace contains RB #0, 10, 20, 30, 40, 50, 60, 70, 80, 90, then the first sub-interlace (first segment, containing RB #0, 10, 20, 30, 40) may be allocated to a first UE while the second sub-interlace (second segment, containing RB #50, 60, 70, 80, 90) may be allocated to a second UE. For another example, the first sub-interlace (containing RB #0, 20, 40, 60, 80) may be allocated to a first UE while the second sub-interlace (containing RB #10, 30, 50, 70, 90) may be allocated to a second UE. That is, a sub-interlace may contain every Q RB within an interlace (here, Q=2). Alternatively, a sub-interlace may include the whole bandwidth of the interlace it belongs to. Alternatively, a sub-interlace may include the whole bandwidth of the unlicensed carrier it lives. With this method, multiple wireless communication devices may transmit a reference signal for positioning simultaneously within an interlace where the bandwidth of an unlicensed carrier can be shared.

Alternatively, this method can be applied to a UE under radio resource control (RRC) connected state (RRC_Connected) or RRC_Inactive state or RRC_Idle state.

With this method, multiple positioning related wireless communication devices may share an unlicensed carrier at the same time (e.g., interlace RB-based FDM).

### Implementation Example 4: Last Symbol(s) of Reference Signal for Positioning Within a Channel Occupancy Time (COT)

For an unlicensed carrier, for a frame based equipment (FBE), a channel occupancy time (COT) is limited (e.g., in Europe, 10 ms at most for one transmission. e.g., 1 ms at most for sidelink synchronization signal block, S-SSB transmission with a Type 2A channel access procedure without a shared channel occupancy).

If a COT reduces to a small duration, then the positioning related channel/signal will not be transmitted (e.g., the last one/several symbol(s) of reference signal for positioning will be dropped). Alternatively, for a Comb based transmission of PRS/SRS/SL-PRS, if the remaining duration of a COT is less than CombSize OFDM symbols, then the last RemainingDuration−CombSize/Q OFDM symbols will be dropped where Q is an integer (e.g., Q=2). For example, if the remaining duration of a COT is 3 symbols while CombSize=4 and Q=2, then the RemainingDuration−CombSize/Q=3−4/2=1 symbol will be dropped, wherein, the integer Q (e.g., Q=2) may be used to generate a partial staggering pattern of reference signal for positioning.

Alternatively, if a DL/UL/SL reference reduces to a small duration, then the positioning related channel/signal will not be transmitted (e.g., the last one/several symbol(s) of reference signal for positioning will be dropped) wherein, a PRS/SRS/SL-PRS may be transmitted in the DL/UL/SL reference duration. Alternatively, a PRS/SRS/SL-PRS with (feedback of) PSFCH may be transmitted in the DL/UL/SL reference duration.

Alternatively, for a Comb based transmission of PRS/SRS/SL-PRS, if the remaining duration of a COT is less than CombSize OFDM symbols and more than or equal to CombSize/2 OFDM symbols, then the last RemainingDuration−CombSize/2 OFDM symbols will be dropped. With this method, the channel (i.e., carrier) will be utilized more efficient because other wireless communication devices may utilize the channel.

Alternatively, for a Comb based transmission of PRS/SRS/SL-PRS with repetition, if the remaining duration of a COT is less than CombSize*RepetitionFactor OFDM symbols, then the last RemainingDuration−CombSize*RepetitionFactor/Q OFDM symbols will be dropped where RepetitionFactor is an integer (e.g., RepetitionFactor=2). For example, if the remaining duration of a COT is 5 symbols while CombSize=4, RepetitionFactor=2 and Q=2, then the RemainingDuration−CombSize*RepetitionFactor/Q=5−4*2/2=1 symbol will be dropped.

Alternatively, for a Comb based transmission of PRS/SRS/SL-PRS without repetition (i.e., RepetitionFactor=1), if the remaining duration of a COT is less than P*CombSize OFDM symbols and more than or equal to CombSize OFDM symbols, then the last RemainingDuration−(P−1)*CombSize OFDM symbols will be a repetition of the first CombSize−1 OFDM symbols where P is an integer (e.g., P=2). For example, if the remaining duration of a COT is 7 symbols while CombSize=4 and P=2, then the RemainingDuration−(P−1)*CombSize=7−(2−1)*4=3 symbol will be a repetition of the first CombSize−1=3 OFDM symbols. With this method, at the reception end, the signal power to noise power ration (SNR) of reference signal for positioning will be improved. Hence, the positioning accuracy may be improved.

Alternatively, a COT duration (of a LBT/CCA type) is associated with a Comb size of reference signal for positioning. For example, if the Comb size of PRS/SRS/SL-PRS is 1, 2, 3, 4, 6, 12, 24, 36, 48, then the COT duration will be CombSize+AGC_Symbol (i.e., 2, 3, 4, 5, 7, 13, 25, 37, 49 symbols, respectively). Alternatively, the COT duration will be CombSize+AGC_Symbol plus occupancy channel/signal (or CPE) duration.

Alternatively, a COT duration (of a LBT/CCA type) is associated with a Comb size and repetition factor of reference signal for positioning. For example, the COT duration will be CombSize*Repetition+AGC_Symbol. For another example, the COT duration will be CombSize*Repetition+AGC_Symbol plus occupancy signal/channel (or CPE) duration.

Some slots that contain SSB (or S-SSB) may not be used for SL communication. Furthermore, some slots reserved may not be used for SL communication (e.g., not for Rel-16/17/18 sidelink UE). A slot that contains SSB (or S-SSB) may be used for SL-PRS (and/or PSCCH that schedules SL-PRS) and may improve the resource efficiency (and/or to reduce positioning delay) wherein, on the OFDM symbols for SSB (or S-SSB), the RB (or frequency resources) for SSB (or S-SSB) are unavailable for SL-PRS/PSCCH that schedules SL-PRS. Alternatively, on the OFDM symbols for SSB (or S-SSB), the RB (or frequency resources) for SSB (or S-SSB) may be in a SL-PRS/PSCCH that schedules SL-PRS, but they are rate matched (or, punctured. That is, without actual transmission of SL-PRS/PSCCH on these time-frequency resources that are for SSB/S-SSB).

Alternatively, a slot that is reserved which is unavailable for Rel-16/17/18 sidelink UE may be used for SL-PRS (and/or PSCCH that schedules SL-PRS) wherein, the SL-PRS (and/or PSCCH that schedules SL-PRS) is for Rel-19 sidelink UE (and/or later).

With this method, the UE behavior may be determined and the unlicensed channel (i.e., unlicensed carrier) will be utilized more efficiently.

### Implementation Example 5: COT Sharing Among Multiple Wireless Communication Devices

After a successful competition of an unlicensed channel (i.e., unlicensed carrier), i.e., a successful LBT/CCA, a radio device (e.g., a gNB, or a UE) may share this unlicensed channel to another wireless communication device within this COT duration (or maximum COT, or maximum COT duration). Moreover, this is helpful for DL positioning (that requires transmission from multiple gNB).

The COT sharing may be indicated by a downlink control information (DCI) on PDCCH or a sidelink control information (SCI) on PSCCH/PSSCH/second stage SCI for SL-PRS. This may enable simultaneous transmission of SL-PRS from multiple UE (similar to that of DL positioning).

An energy detection threshold may be included in the COT sharing information (e.g., Th=−100 dBm). Alternatively, the energy detection threshold is associated with number of simultaneous transmission of SL-PRS/SRS of UE (or PRS of gNB). For example, the energy detection threshold is Th=−100 dBm+10*log₁₀(NumberOfUE). Alternatively, the energy detection threshold is Th=Th_for_Non_COT_Sharing+10*log₁₀(NumberOfUE), where the energy detection threshold for non-COT sharing (or COT non-sharing, e.g., 72 dBm for frequency range 1, FR 1, while −80 dBm for FR 2. That is, energy detection threshold is different for FR 1 and FR 2). Alternatively, the energy detection threshold may be for configured grant (CG) scheduling (or semi-persistence grant, SG, or dynamic grant, DG). Alternatively, the energy detection threshold may be based on a bandwidth. For example, 20 MHz, e.g., Th=(Th_for_Non_COT_Sharing+10*log₁₀(NumberOfUE))/20 MHz, or Th=Th_for_Non_COT_Sharing@20 MHz+10*log₁₀(NumberOfUE), or Th=Th_for_Non_COT_Sharing_per_MHz+10*log₁₀(NumberOfUE) where the Th_for_Non_COT_Sharing_per_MHz is the energy detection threshold based on a bandwidth of 1 MHz.

Alternatively, the energy detection threshold is associated with the CombSize of SL-PRS/SRS/PRS. For example, the energy detection threshold is Th=−100 dBm−10*log₁₀(CombSize) or Th=BaseThreshold_in_dBm+10*log₁₀(CombSize). Alternatively, the energy detection threshold is Th=Th_for_Non_COT_Sharing+10*log₁₀(CombSize).

Alternatively, if the energy detection threshold is not configured, then the shared COT may only be transmitted within a duration wherein, the duration may be less than or equal to CombSize OFDM symbols (e.g., 1, 2, 3, 4 symbols).

Alternatively, a maximum energy detection threshold (or an energy detection threshold) may be associated with at least one of: channel bandwidth (or carrier bandwidth), bandwidth of sub-channel, bandwidth of resource pool (RP), number of sub-channels, bandwidth part (BWP), NumberOfUE, CombSize, number of interlaces, number of interlaced resources, number of interlaced RB. Alternatively, a maximum energy detection threshold (or an energy detection threshold) for COT sharing may be associated with at least one of: channel bandwidth (or carrier bandwidth), bandwidth of sub-channel, bandwidth of RP, number of sub-channels, BWP, NumberOfUE, CombSize, number of interlaces, number of interlaced resources, number of interlaced RB. Alternatively, a maximum energy detection threshold (or an energy detection threshold) for an initiated COT (e.g., an gNB-initiated COT) may be associated with at least one of: channel bandwidth (or carrier bandwidth), bandwidth of sub-channel, bandwidth of RP, number of sub-channels, BWP, NumberOfUE, CombSize, number of interlaces, number of interlaced resources, number of interlaced RB. Alternatively, a maximum energy detection threshold (or an energy detection threshold) for COT non-sharing may be associated with at least one of: channel bandwidth (or carrier bandwidth), bandwidth of sub-channel, bandwidth of RP, number of sub-channels, BWP, NumberOfUE, CombSize, number of interlaces, number of interlaced resources, number of interlaced RB.

Alternatively, for a shared COT, the transmission bandwidth should be within the BWP of the initiated COT (e.g., for frequency range 1 or 2, FR 1 or 2). Alternatively, for a UE under RRC Inactive/RRC_Idle state, for a shared COT, the transmission bandwidth can be outside the BWP of the initiated COT (e.g., for FR 2-2). Alternatively, for a UE under RRC Inactive/RRC_Idle state, for a shared COT, the transmission bandwidth can be outside the BWP of the initiated COT but within the bandwidth of the initiated COT (e.g., for FR 2).

A quasi-co-location (QCL) information may be included in the COT sharing information. The QCL information may include QCL type (e.g., type A/B/C/D) and QCL source (e.g., synchronization signal block, SSB, SSB index, CSI-RS, CSI-RS resource index, PRS resource index, SRS resource index, SL-PRS resource index). Moreover, this is helpful for beamforming based transmission of SL-PRS/SRS/PRS (e.g., in frequency range 2, FR2).

A transmission configuration indicator (TCI) information may be included in the COT sharing information. The TCI information can include QCL type and QCL reference signal. Moreover, this is helpful for beamforming-based transmission of SL-PRS/SRS/PRS.

An interlace information can be included in the COT sharing information. Alternatively, the energy detection threshold is associated with the number of interlaces. Alternatively, the energy detection threshold is associated the number of interlaced RB.

A frequency and bandwidth information may be included in the COT sharing information. Alternatively, (an available) LBT/CCA bandwidth may be included in the COT sharing information. For example, if one UE had occupied one 100 MHz bandwidth (after a successful LBT/CCA), then this UE can share its COT on a 20 MHz, a 40 MHz, another 40 MHz for a first UE, a second UE, a third UE as LBT/CCA bandwidth, respectively.

A beam-related information (e.g., bearing angle, boresight angle, PRS resource index, SL-PRS resource index) may be included in the COT sharing information.

With this method, a COT may be shared among multiple wireless communication devices, which will enable multiple sites positioning and the unlicensed channel (i.e., unlicensed carrier) will be utilized more efficiently.

### Implementation Example 6: Beam Management/Maintenance for Reference Signal for Positioning

A reference signal for positioning may be transmitted in a form of beamforming, which will improve reception signal quality at a receiver.

In a RP (e.g., a dedicated RP, or a shared RP), a CSI-RS (or DM-RS, e.g., DM-RS of PSCCH that schedules SL-PRS) may be transmitted with SL-PRS/PRS in a form of time division multiplexing (TDM, e.g., CSI-RS first, then SL-PRS/PRS) with identical beam (or beam index, or beam direction, or CSI-RS resource index). This CSI-RS may be the beam reference (or QCL source, or QCL reference) of SL-PRS/PRS when a UE measures SL-PRS/PRS.

Alternatively, a CSI-RS may be transmitted simultaneously with SL-PRS/PRS in a form of Comb (e.g., Comb-based FDM) with different Comb offset. For example, for a CombSize=2, a CSI-RS is transmitted on CombOffset=0 while SL-PRS/PRS on CombOffset=1.

Alternatively, a SL-PRS/PRS/SRS in one RP (or resource, or resource set) can be the beam reference (or QCL source, or QCL reference) of SL-PRS/PRS/SRS in another RP (or resource, or resource set) when a radio device measures SL-PRS/PRS/SRS. Moreover, this method is helpful for cross-pool beam management.

Alternatively, when a wireless communication device (e.g., UE, or gNB, or transmission and reception point, TRP) reports measurement result(s) of SL-PRS/PRS/SRS, a resource index (e.g., PRS resource index, SL-PRS resource index, SRS resource index) is attached. Moreover, this method is helpful for beam management/maintenance. Alternatively, a beam index is attached.

Alternatively, when a wireless communication device (e.g., UE, or gNB, or transmission and reception point, TRP) reports measurement result(s) of SL-PRS/PRS/SRS, a timestamp (e.g., system frame number, SFN, device frame number, DFN, slot number within a frame, symbol index within a slot, start symbol index, end symbol index), when measuring SL-PRS/PRS/SRS, is attached. Moreover, this method is helpful for beam management/maintenance with beam sweeping/repetition and indicates which beam is referred and when a beam is referred.

Alternatively, the CSI-RS that serves as beam reference (or QCL source, or QCL reference) for SL-PRS/PRS/SRS may be carried by a PSSCH as accompanying data.

Alternatively, one (or multiple) PSFCH can be used to feedback for which beam direction (or SL-PRS/PRS/SRS resource, or SL-PRS/PRS/SRS resource index) is measured (or measured with the highest reference signal received power, RSRP value), wherein a PSFCH can share the COT of SL-PRS/PRS/SRS. Alternatively, each PSFCH may have a separate LBT/CCA (e.g., with a Type A or Type B channel access procedure). Alternatively, a set of PSFCH may have a LBT/CCA. Alternatively, a set of PSFCH may have a LBT/CCA where these PSFCH are transmitted at the same time. For example, if a PSFCH corresponding to a SL-PRS resource index is transmitted, then this beam direction of SL-PRS is the best direction. If a PSFCH corresponding to a SL-PRS resource index is not transmitted, then this beam direction is not measured (or not available). Alternatively, a PSFCH with a value of “1” (or a value for positive acknowledgement, ACK) means the corresponding SL-PRS (or SL-PRS resource) is transmitted while a value of “0” (or a value for negative acknowledgement, NACK) for “not transmitted”.

Alternatively, a cyclic shift of SL-PRS/PRS/SRS can be used to feedback for beam direction (e.g., cyclic shift #5 for beam direction #5, one to one mapping). Alternatively, a cyclic shift of SL-PRS/PRS/SRS can be used to feedback for which beam direction (or SSB, or SSB index, or SL-PRS/PRS/SRS resource, or SL-PRS/PRS/SRS resource index) is measured.

Alternatively, when a wireless communication device measures differential carrier phase (with a pair of carrier phase measurements, or two carrier phase measurements), an identical phase error group (PEG) is applied (for this pair of carrier phase measurements). Alternatively, a PEG may be with zero phase error margin. Alternatively, the timing of carrier phase measurement may be the start of an OFDM symbol, where a SL-PRS/PRS/SRS (or SL-PRS/PRS/SRS resource) is transmitted.

Alternatively, for a SL-PRS/PRS/SRS transmission/reception with hopping (e.g., for a reduced capability UE, RedCap UE), the data (e.g., PDSCH/PUSCH for reporting positioning related data, e.g., assistance data of positioning, measurement result) transmission/reception can be transmitted (or received) with hopping. For example, for a PRS reception with hopping with five hops, a UE may combine the PDSCH on these five hops (if they are in repetition with each other, even with a different redundancy version). For another example, for a SRS transmission with hopping with five hops, a UE may transmit PUSCH repeatedly with five times. With this method, the decoding performance of PDSCH/PUSCH may be improved (e.g., five times improvement on signal quality).

Alternatively, for a SL-PRS/PRS/SRS transmission/reception with hopping (e.g., for a RedCap UE), each hop is transmitted (or received) with an identical beam (or beam direction, or QCL source, or QCL reference, or QCL reference source, or identical TCI information). Alternatively, for a SL-PRS/PRS/SRS transmission/reception with hopping, each hop is associated with the same QCL reference (e.g., the same SSB, the same SSB index, the same CSI-RS resource, the same CSI-RS resource index, the same SL-PRS/PRS/SRS resource, the same SL-PRS/PRS/SRS resource index). Alternatively, the QCL reference (or QCL source) may be attached in a measurement report (with timestamp).

Alternatively, for a SL-PRS/PRS/SRS transmission/reception with hopping, PRS reception (Rx) frequency hopping can be applied for a RedCap UE under RRC_INACTIVE state. Inwhere, a measurement gap (MG) can be configured for it. Inwhere, the configuration of MG can be performed via a RRC release message before it entering RRC_INACTIVE state from RRC_Connected state. Alternatively, the configuration of MG can be broadcasted in a system information block (SIB). Alternatively, the measurement gap length (MGL) of MG can be 20 ms, 40 ms, 60 ms, 80 ms, 100 ms, 200 ms, 1000 ms.

Alternatively, for a SL-PRS/PRS/SRS transmission/reception with hopping, if a full bandwidth of PRS/SRS reception could not be ensured, only the measurement result of one hop is reported. Otherwise, the measurement result of all the hops (or full bandwidth of PRS/SRS reception) is reported. Alternatively, a hop with the highest RSRP, and/or the highest SNR, and/or the largest bandwidth is reported.

Alternatively, for a SL-PRS/PRS/SRS transmission/reception with hopping, a common starting physical resource block (PRB) for all the UE can be configured by higher layer (e.g., RRC of base station, RRC of another UE). Alternatively, the first hop (e.g., a hop with hop ID 0, or a hop with the lowest frequency, or a hop with the highest frequency) is configured with a starting PRB. Alternatively, the bandwidth of a hop is configured by higher layer. Alternatively, each hop can have an identical value of bandwidth configured by higher layer. Alternatively, the configured RB number of configured bandwidth is less than or equal to that of UE capability (e.g., for 20 MHz of UE capability, 51 RB at most under SCS=30 kHz).

With this method, a beamforming of SL-PRS/PRS/SRS may be managed/maintained effectively.

It should be understood that one or more features from the above implementation examples are not exclusive to the specific implementation examples, but can be combined in any manner (e.g., in any priority and/or order, concurrently or otherwise).

FIG. 5 illustrates a flow diagram of a method 500 for signal transmission under an unlicensed carrier (or shared spectrum). The method 500 may be implemented using any one or more of the components and devices detailed herein in conjunction with FIGS. 1-2. In overview, the method 500 may be performed by a wireless communication device or a wireless communication node, in some embodiments. Additional, fewer, or different operations may be performed in the method 500 depending on the embodiment. At least one aspect of the operations is directed to a system, method, apparatus, or a computer-readable medium.

A wireless communication entity (e.g., a UE, a radio device) may receive configuration information about a reference signal for positioning (e.g., a positioning reference signal (PRS)) from a wireless communication node. The wireless communication entity may send a transmission of the reference signal for positioning. The transmission may include an occupancy signal based on a de-modulation reference signal (DM-RS) of a physical sidelink control channel (PSCCH) that schedules the reference signal for positioning.

In some embodiments, the transmission may include an occupancy signal based on an automatic gain control (AGC) symbol that is just before a PSCCH that schedules the reference signal for positioning. The transmission may include an occupancy signal based on a de-modulation reference signal (DM-RS) of a physical downlink control channel (PDCCH) that schedules the reference signal for positioning. The transmission may include an occupancy signal based on an automatic gain control (AGC) symbol that is just before a PSCCH that schedules the reference signal for positioning.

In some embodiments, the configuration information may indicate that when a time-gap between a successful listen before talk (LBT)/clear channel assessment (CCA) and a pre-defined start time of a PSCCH that schedules the reference signal for positioning is greater or equal to the first wireless communication entity processing capability of AGC, sending the transmission. The transmission may include an occupancy signal copied from an incoming PSCCH symbol.

In some embodiments, the reference signal for positioning may be configured as a Comb-based signal, and wherein when a time-gap between a successful LBT/CCA and a pre-defined end time of the reference signal for positioning is less than CombSize/Q orthogonal frequency division multiplexing (OFDM) symbol(s), the reference signal for positioning is not sent, where CombSize is a comb size and Q is an integer. The reference signal for positioning may be configured as a Comb-based signal, and wherein when a time-gap between a successful LBT/CCA and a pre-defined end time of the reference signal for positioning is less than CombSize OFDM symbol(s), the reference signal for positioning is not sent, where CombSize is a comb size. The reference signal for positioning may be configured as a Comb-based signal, and wherein when a time-gap between a successful LBT/CCA and a pre-defined end time of the reference signal for positioning is less than CombSize/Q OFDM symbol(s) plus a duration for AGC, the reference signal for positioning is not sent, where CombSize is a comb size and Q is an integer. The reference signal for positioning may be configured as a Comb-based signal, and wherein when a time-gap between a successful LBT/CCA and a pre-defined end time of a PSCCH that schedules the reference signal for positioning is less than CombSize/Q OFDM symbol(s) plus a duration for AGC, the reference signal for positioning is not sent, where CombSize is a comb size and Q is an integer. The reference signal for positioning may be configured as a Comb-based signal, and wherein when a time-gap between a successful LBT/CCA and a pre-defined end time of the reference signal for positioning is less than CombSize OFDM symbol(s) plus duration for AGC, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for AGC, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for a PSCCH/PDCCH that schedules the reference signal for positioning, the reference signal for positioning is not sent, where CombSize is a comb size. The reference signal for positioning may be configured as a Comb-based signal, and wherein when a time-gap between a successful LBT/CCA and a pre-defined end time of a PSCCH that schedule the reference signal for positioning is less than CombSize OFDM symbol(s) plus a duration for AGC and a duration for a PSCCH/PDCCH that schedules the reference signal for positioning, the reference signal for positioning is not sent, where CombSize is a comb size.

In some embodiments, the configuration information may indicate an LBT/CCA type associated with CombSize of the reference signal for positioning, where CombSize is a comb size. The configuration information may indicate that a PSCCH starts with a first interlace while the reference signal for positioning starts with a second interlace. The configuration information may indicate that every M RBs out of a bandwidth composes an interlace, where M is an integer. The configuration may indicate one or more CombSize interlaces for the transmission of the reference signal positioning, where CombSize is a comb size. The configuration information may indicate information indicates an interlace that contains RBs, each of the RBs associated with an RB index. The configuration information may indicate more than one sub-interlace within an interlace. The configuration information may indicate a sub interlace indicator in a PSCCH/PSSCH/PDCCH.

In some embodiments, the reference signal for positioning may be configured as a Comb-based signal, and wherein when a remaining duration of a COT (RemainingDuration) is less than CombSize OFDM symbols, RemainingDuration−CombSize/Q OFDM symbols are dropped, where CombSize is a comb size and Q is an integer. In some embodiments, the reference signal for positioning may be configured as a Comb-based signal, and wherein when a remaining duration of a COT (RemainingDuration) is less than CombSize×RepetitionFactor OFDM symbols, RemainingDuration−CombSize×RepetitionFactor/Q OFDM symbols are dropped, where CombSize is a comb size and Q is an integer. In some embodiments, the reference signal for positioning may be configured as a Comb-based signal, and wherein when a remaining duration of a COT (RemainingDuration) is less than P×CombSize OFDM symbols and more than or equal to CombSize OFDM symbols, RemainingDuration−(P−1)×CombSize OFDM symbols are a repetition of CombSize−1 OFDM symbols, where CombSize is a comb size and P is an integer.

In some embodiments, the configuration information may include an energy detection threshold, and wherein the energy detection threshold is included in COT sharing information. In some embodiments, the energy detection threshold may be associated with a number of simultaneous transmissions of the reference signal for positioning. The energy detection threshold may be associated with Comb Size of the reference signal for positioning. The energy detection threshold may be associated with a number of interlaces.

In some embodiments, the configuration information may indicate quasi-co-location (QCL) information included in COT sharing information. The configuration information may indicate a transmission configuration indicator included in COT sharing information. The configuration information may indicate interlace information included in COT sharing information. The configuration information may indicate a LBT/CCA bandwidth included in COT sharing information. The configuration information may indicate the reference signal for positioning in one resource pool (RP) (or resource, or resource set) as a beam reference (or QCL source) of another reference signal for positioning in another RP. The configuration information may indicate that when a wireless communication device reports measurement results of the reference signal for positioning, a resource index is attached. The configuration information may indicate that when a wireless communication device reports measurement results of the reference signal for positioning a timestamp is attached. The configuration information may indicate a physical sidelink feedback channel (PSFCH) for measuring a beam direction. In some embodiments, the PSFCH shares a COT of the reference signal for positioning. The configuration information may indicate that the reference signal for positioning starts at symbol ID when mod(SymbolID, CombSize)==T is satisfied, wherein SymbolID is a symbol ID within a slot, CombSize is a comb size of the reference signal for positioning, and T is an integer.

In some embodiments, the transmission may include a COT duration associated with a comb size of the reference signal for positioning or a repetition factor of the reference signal for positioning.

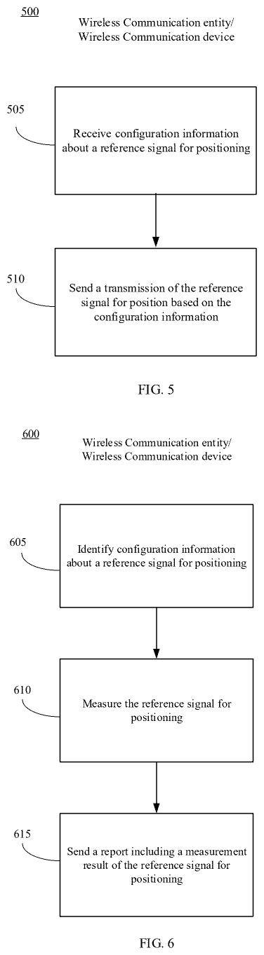

FIG. 6 illustrates a flow diagram of a method 600 for signal reception under an unlicensed carrier (or shared spectrum). The method 600 may be implemented using any one or more of the components and devices detailed herein in conjunction with FIGS. 1-2. In overview, the method 600 may be performed by a wireless communication device or a wireless communication node, in some embodiments. Additional, fewer, or different operations may be performed in the method 600 depending on the embodiment. At least one aspect of the operations is directed to a system, method, apparatus, or a computer-readable medium.

In some embodiments, a wireless communication device may identify configuration information about a reference signal for positioning sent from a second wireless communication device. The wireless communication device may measure the reference signal for positioning. The wireless communication device may send a report including a measurement result of the reference signal for positioning. In some embodiments, the measurement result may include the reference signal for positioning in one RP (or resource, or resource set) as a beam reference (or QCL source) of another reference signal for positioning in another RP.

In some embodiments, the configuration information may indicate that when sending the report, a resource index should be attached. In some embodiments, the resource index may include a PRS resource index, a SL-PRS resource index, or a SRS resource index. The configuration information may indicate that when sending the report, a timestamp can be attached. In some embodiments, the timestamp may include a system frame number (SFN), a slot number within a frame, or a symbol index within a slot.

1. A wireless communication method, comprising:
receiving, by a first wireless communication entity from a second wireless communication entity, configuration information about a reference signal for positioning;
sending, by the first wireless communication entity to the second wireless communication entity, a transmission of the reference signal for positioning based on the configuration information.

2. The wireless communication method of claim 1, wherein
the transmission further includes an occupancy signal based on a de-modulation reference signal (DM-RS) of a physical sidelink control channel (PSCCH) that schedules the reference signal for positioning;
or,
the transmission further includes an occupancy signal based on a de-modulation reference signal (DM-RS) of a physical downlink control channel (PDCCH) that schedules the reference signal for positioning;
or
the transmission further includes an occupancy signal based on an automatic gain control (AGC) symbol that is just before a PSCCH that schedules the reference signal for positioning;
and/or,
the transmission further includes an occupancy signal copied from an incoming PSCCH symbol.

3. (canceled)

4. (canceled)

5. The wireless communication method of claim 1, further comprising:
when a time-gap between a successful listen before talk (LBT)/clear channel assessment (CCA) and a pre-defined start time of a PSCCH that schedules the reference signal for positioning is greater or equal to the first wireless communication entity processing capability of AGC, sending the transmission.

6. (canceled)

7. The wireless communication method of claim 1, wherein
the reference signal for positioning is configured as a Comb-based signal, and wherein when a time-gap between a successful LBT/CCA and a pre-defined end time of the reference signal for positioning is less than CombSize/Q orthogonal frequency division multiplexing (OFDM) symbol(s), the reference signal for positioning is not sent, where CombSize is a comb size and Q is an integer;
or,
the reference signal for positioning is configured as a Comb-based signal, and wherein when a time-gap between a successful LBT/CCA and a pre-defined end time of the reference signal for positioning is less than CombSize OFDM symbol(s), the reference signal for positioning is not sent, where CombSize is a comb size;
or,
the reference signal for positioning is configured as a Comb-based signal, and wherein when a time-gap between a successful LBT/CCA and a pre-defined end time of the reference signal for positioning is less than CombSize/Q OFDM symbol(s) plus a duration for AGC, the reference signal for positioning is not sent, where CombSize is a comb size and Q is an integer;
or,
the reference signal for positioning is configured as a Comb-based signal, and wherein when a time-gap between a successful LBT/CCA and a pre-defined end time of a PSCCH that schedules the reference signal for positioning is less than CombSize/Q OFDM symbol(s) plus a duration for AGC, the reference signal for positioning is not sent, where CombSize is a comb size and Q is an integer;
or,
the reference signal for positioning is configured as a Comb-based signal, and wherein when a time-gap between a successful LBT/CCA and a pre-defined end time of the reference signal for positioning is less than CombSize OFDM symbol(s) plus duration for AGC, the reference signal for positioning is not sent, where CombSize is a comb size;
or,
the reference signal for positioning is configured as a Comb-based signal, and wherein when a time-gap between a successful LBT/CCA and a pre-defined end time of a PSCCH that schedule the reference signal for positioning is less than CombSize OFDM symbol(s) plus a duration for AGC, the reference signal for positioning is not sent, where CombSize is a comb size;
or,
the reference signal for positioning is configured as a Comb-based signal, and wherein when a time-gap between a successful LBT/CCA and a pre-defined end time of a PSCCH that schedule the reference signal for positioning is less than CombSize/OFDM symbol(s) plus a duration for a PSCCH/PDCCH that schedules the reference signal for positioning, the reference signal for positioning is not sent, where CombSize is a comb size;
or,
the reference signal for positioning is configured as a Comb-based signal, and wherein when a time-gap between a successful LBT/CCA and a pre-defined end time of a PSCCH that schedule the reference signal for positioning is less than CombSize/OFDM symbol(s) plus a duration for AGC and a duration for a PSCCH/PDCCH that schedules the reference signal for positioning, the reference signal for positioning is not sent, where CombSize is a comb size.

8. (canceled)

9. (canceled)

10. (canceled)

11. (canceled)

12. (canceled)

13. (canceled)

14. (canceled)

15. The wireless communication method of claim 1, wherein
the configuration information indicates an LBT/CCA type associated with CombSize of the reference signal for positioning, where CombSize is a comb size;
or,
the configuration information indicates that a PSCCH starts with a first interlace while the reference signal for positioning starts with a second interlace;
or,
the configuration information indicates that every M RBs out of a bandwidth composes an interlace, where M is an integer;
or,
the configuration information indicates one or more CombSize interlaces for the transmission of the reference signal positioning, where CombSize is a comb size;
or,
the configuration information indicates an interlace that contains RBs, each of the RBs associated with an RB index;
or,
the configuration information indicates more than one sub-interlace within an interlace;
or,
the configuration information indicates a sub-interlace indicator in a PSCCH/PSSCH/PDCCH.

16. (canceled)

17. (canceled)

18. (canceled)

19. (canceled)

20. (canceled)

21. (canceled)

22. The wireless communication method of claim 1, wherein
the reference signal for positioning is configured as a Comb-based signal, and wherein when a remaining duration of a COT (RemainingDuration) is less than Comb Size OFDM symbols, RemainingDuration−CombSize/Q OFDM symbols are dropped, where CombSize is a comb size and Q is an integer;
or,
the reference signal for positioning is configured as a Comb-based signal, and wherein when a remaining duration of a COT (RemainingDuration) is less than CombSize×RepetitionFactor OFDM symbols, RemainingDuration−CombSize×RepetitionFactor/Q OFDM symbols are dropped, where CombSize is a comb size and Q is an integer;
or,
the reference signal for positioning is configured as a Comb-based signal, and wherein when a remaining duration of a COT (RemainingDuration) is less than P×CombSize OFDM symbols and more than or equal to CombSize OFDM symbols, RemainingDuration−(P−1)×CombSize OFDM symbols are a repetition of CombSize−1 OFDM symbols, where CombSize is a comb size and P is an integer.

23. (canceled)

24. (canceled)

25. The wireless communication method of claim 1, wherein the configuration information includes an energy detection threshold, and wherein the energy detection threshold is included in COT sharing information.

26. The wireless communication method of claim 25, wherein
the energy detection threshold is associated with a number of simultaneous transmissions of the reference signal for positioning;
or,
the energy detection threshold is associated with CombSize of the reference signal for positioning;
or,
the energy detection threshold is associated with a number of interlaces.

27. (canceled)

28. (canceled)

29. The wireless communication method of claim 1, wherein
the configuration information indicates quasi-co-location (QCL) information included in COT sharing information;
or,
the configuration information indicates a transmission configuration indicator included in COT sharing information;
or,
the configuration information indicates interlace information included in COT sharing information;
or,
the configuration information indicates a LBT/CCA bandwidth included in COT sharing information;
or,
the configuration information indicates the reference signal for positioning in one resource pool (RP), or resource, or resource set as a beam reference or QCL source of another reference signal for positioning in another RP;
or,
the configuration information indicates that when a wireless communication device reports measurement results of the reference signal for positioning, a resource index is attached;
or,
the configuration information indicates that when a wireless communication device reports measurement results of the reference signal for positioning a timestamp is attached.

30. (canceled)

31. (canceled)

32. (canceled)

33. (canceled)

34. (canceled)

35. (canceled)

36. The wireless communication method of claim 1, wherein the configuration information indicates a physical sidelink feedback channel (PSFCH) for measuring a beam direction.

37. The wireless communication method of claim 36, wherein the PSFCH shares a COT of the reference signal for positioning.

38. The wireless communication method of claim 1, wherein the configuration information indicates that the reference signal for positioning starts at symbol ID when mod(SymbolID, CombSize)==T is satisfied, wherein SymbolID is a symbol ID within a slot, CombSize is a comb size of the reference signal for positioning, and T is an integer.

39. The wireless communication method of claim 1, wherein the transmission includes a COT duration associated with a comb size of the reference signal for positioning or a repetition factor of the reference signal for positioning.

40. A wireless communication method, comprising:
identifying, by a first wireless communication device, configuration information about a reference signal for positioning sent from a second wireless communication device;
measuring, by the first wireless communication device, the reference signal for positioning; and
sending, by the first wireless communication device, a report including a measurement result of the reference signal for positioning.

41. The wireless communication method of claim 40, wherein
the measurement result includes the reference signal for positioning in one RP, or resource, or resource set as a beam reference or QCL source of another reference signal for positioning in another RP;
or,
the configuration information indicates that when sending the report, a resource index should be attached.

42. (canceled)

43. The wireless communication method of claim 41, wherein
the resource index includes a PRS resource index, a SL-PRS resource index, or a SRS resource index;
or,
the configuration information indicates that when sending the report, a timestamp can be attached, wherein the timestamp includes a system frame number (SFN), a slot number within a frame, or a symbol index within a slot.

44. (canceled)

45. (canceled)

46. A wireless communications apparatus comprising a processor and a memory, wherein the processor is configured to read code from the memory and implement a method recited in claim 1.

47. A computer program product comprising a computer-readable program medium code stored thereupon, the code, when executed by a processor, causing the processor to implement a method recited in claim 1.

48. A wireless communications apparatus comprising a processor and a memory, wherein the processor is configured to read code from the memory and implement a method recited in claim 40.

49. A computer program product comprising a computer-readable program medium code stored thereupon, the code, when executed by a processor, causing the processor to implement a method recited in claim 40.
